(19) United States
(12) Patent Application Publication
(10) Pub. No.: US 2026/0154075 A1
(43) Pub. Date: Jun. 4, 2026

(54) SCHEME FOR INCREASING INSTRUCTION THROUGHPUT FROM CENTRAL PROCESSING UNIT(CPU) TO HARDWARE ACCELERATOR

(71) Applicant: QUALCOMM Incorporated, San Diego, CA (US)

(72) Inventors: Bharat Kumar RANGARAJAN, Bangalore (IN); Paul KITCHIN, Austin, TX (US)

(21) Appl. No.: 19/225,903

(22) Filed: Jun. 2, 2025

Related U.S. Application Data
(63) Continuation of application No. 18/968,330, filed on Dec. 4, 2024.

(51) Int. Cl. G06F 9/38; G06F 9/30

(52) U.S. Cl. CPC G06F 9/30036; G06F 9/3853; G06F 9/3877

(57) ABSTRACT

Certain aspects of the present disclosure provide techniques and apparatus for communicating scalable matrix extension (SME) requests to a hardware accelerator. Aspects include sending a first SME request to a buffer of a central processing unit. Aspects include sending a second SME request to the buffer. Aspects include merging the first SME request in the buffer and second SME request in the buffer to generate a request packet. Aspects include sending the request packet to the hardware accelerator.

### CROSS-REFERENCE TO RELATED APPLICATION(S)

This present application is a continuation of U.S. patent application Ser. No. 18/968,330, filed Dec. 4, 2024, which is hereby incorporated by reference herein.

### TECHNICAL FIELD

Aspects of the present disclosure generally relate to a CPU and, more particularly, to a scheme for increasing instruction throughput from the CPU to a hardware accelerator, such as a matrix accelerator, configured to perform computationally intensive tasks (e.g., associated with artificial intelligence/machine learning applications).

### BACKGROUND

A CPU may delegate computationally intensive tasks (e.g., matrix multiplication) to a hardware accelerator, such as a matrix multiplication processing unit, by sending instructions (e.g., scalable matrix extension (SME) requests) to the hardware accelerator via a last-level cache. However, the hardware accelerator can execute more instructions per cycle than the CPU can send the hardware accelerator per clock cycle. As a result, the hardware accelerator operates sub-optimally leading to waste (e.g., in the form of increased idle time) that is generally undesirable.

### BRIEF SUMMARY

Certain aspects provide a method for communicating scalable matrix extension (SME) requests to a hardware accelerator. The method typically includes: sending a first SME request to a buffer of a central processing unit; sending a second SME request to the buffer; merging the first SME request in the buffer and second SME request in the buffer to generate a request packet; and sending the request packet to the hardware accelerator.

Certain aspects provide a processing system. The processing system includes: a hardware accelerator; a last level cache; and CPU. The CPU includes a load-store unit (LSU) and a buffer. The buffer is communicatively coupled to the LSU. The buffer is also communicatively coupled to the hardware accelerator via the last level cache. The CPU is configured to: send a first SME request from the LSU to the buffer; send a second SME request from the LSU to the buffer; merge the first SME request in the buffer and second SME request in the buffer to generate a request packet; and send the request packet to the hardware accelerator via the last level cache.

Certain aspects provide an apparatus. The apparatus includes: means for sending a first SME request to a buffer of a central processing unit; means for sending a second SME request to the buffer; means for merging the first SME request in the buffer and the second SME request in the buffer to generate a request packet; and means for sending the request packet to a hardware accelerator.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts an example CPU cluster according to various aspects of the present disclosure.

FIG. 2 depicts example components of a CPU according to various aspects of the present disclosure.

FIG. 3 depicts an example request packet including merged SME requests according to various aspects of the present disclosure.

FIG. 4 depicts a flow diagram of an example method for communicating SME requests to a hardware accelerator according to various aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, and processing systems for increasing instruction throughput from a CPU to a hardware accelerator.

Example aspects of the present disclosure are directed to techniques for improving the throughput of instructions (e.g., SME requests) that a CPU provides a hardware accelerator. For example, the CPU may include a load store execution unit (LSU) and a request data buffer (RDB). The LSU may send instructions (e.g., SME requests) to the RDB. And, instead of sending the instructions individually like in existing CPUs, the disclosed techniques include merging multiple instructions (e.g., SME requests) at the RDB to generate a request packet that can then be sent to the hardware accelerator (e.g., via a last level cache). By merging the instructions at the RDB to generate the request packet that includes multiple instructions and can be sent during a single clock cycle, the throughput of instructions the CPU provides to the hardware accelerator during a given clock cycle can be improved.

Example aspects of the present disclosure provide numerous technical effects and benefits. For example, by merging instructions (e.g., SME requests) at the RDB, the disclosed techniques improve the throughput of instructions from the CPU to the hardware accelerator such that the throughput of instructions at least matches (and, in some instances, exceeds) the throughput (e.g., number of instructions executed per clock cycle) of the hardware accelerator. In this manner, the disclosed techniques eliminate (or at least reduce) waste associated with sub-optimal operation (e.g., increased idle time) of the hardware accelerator.

### Example CPU Cluster

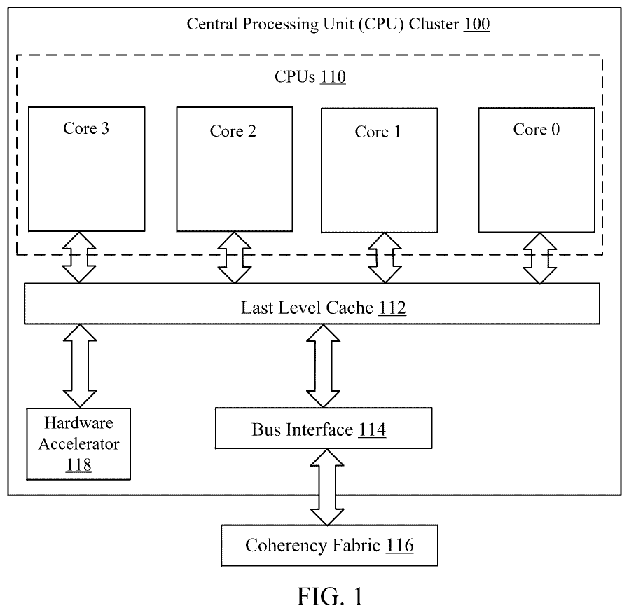

FIG. 1 depicts a block diagram of a CPU cluster 100 according to some aspects of the present disclosure. The CPU cluster 100 may include a plurality of CPUs 110. For example, as illustrated in FIG. 1, the CPU cluster 100 may include four separate CPUs (e.g., labeled as Core 0, Core 1, Core 2, and Core 3). It should be appreciated that the scope of the present disclosure is not intended to be limited to CPU clusters having four separate CPUs and therefore may include CPU clusters having more or fewer CPUs 110.

The CPU cluster 100 may include a last level cache 112 having a much larger storage capacity compared to local memory (e.g., level 1 cache) included in each respective CPU 110 of the CPU cluster 100. The last level cache 112 may be shared amongst the plurality of CPUs 110. Also, as the name suggests, the last level cache 112 represents the final cache before a respective CPU of the plurality of CPUs 110 access the main memory.

The CPU cluster 100 may include a bus interface 114. The bus interface 114 may be a physical (and logical) interface that connects a respective CPU to other components. For example, the bus interface 114 may connect the respective CPU to a coherency fabric 116 (e.g., system bus) that connects the respective CPU to another CPU cluster (not shown) as well as other components, such as main memory

The CPU cluster 100 may include a hardware accelerator 118 configured to execute computationally intensive tasks (e.g., matrix multiplication). The hardware accelerator 118 may be in communication with each respective CPU of the CPUs 110 via the last level cache 112. The hardware accelerator 118 may include two separate pipelines. For example, in some aspects, the two separate pipelines may include a load-store unit (LSU) execution pipeline and a matrix multiplication pipeline. In this manner, the hardware accelerator 118 may be configured to execute two instructions, such as two SME requests, per clock cycle.

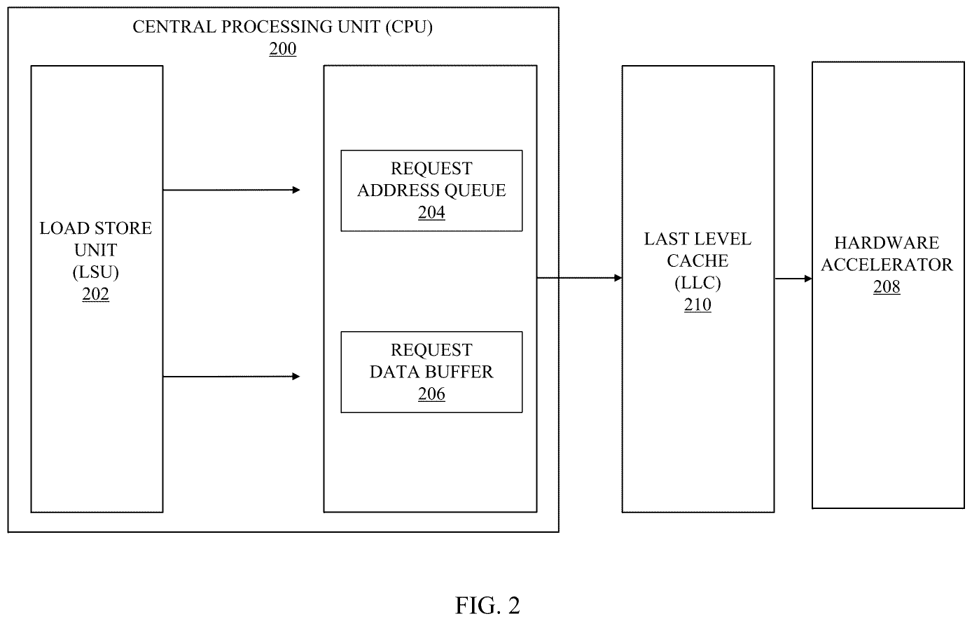

FIG. 2 illustrates components of a CPU 200 according to some aspects of the present disclosure. For example, the CPU 200 may be one of the CPUs 110 included in the CPU cluster 100 discussed above with reference to FIG. 1.

In some aspects, the CPU 200 may include a load-store unit (LSU) 202, a request address queue (RAQ) 204, and a request data buffer (RDB) 206. The LSU 202 may be configured to provide instructions to a hardware accelerator 208 via a last level cache (LLC) 210. For example, in some aspects, the instructions that the LSU 202 provides to the hardware accelerator 208 may include SME requests, scalable vector extension (SVE) requests, or both. In some aspects, SVE instruction set may include instructions that operate on one-dimensional vectors with a scalable length, whereas the SME instruction set may be an extension of SVE instruction set and may include instructions that operate on two-dimensional matrices with fixed dimensions. To send instructions (that is, SME requests, SVE requests, or both) to the hardware accelerator 208 via the LLC 210, the CPU 200 may, in some aspects, enter a streaming mode.

It should be appreciated that the SME may support various computationally-intensive tasks, such as matrix operations that, without limitation, may include: taking the transpose of a matrix; calculating the matrix outer product of vector; and loading/storing matrix vectors. It should also be appreciated that the hardware accelerator 208 may include dedicated matrix processing cores (e.g., CPUs) that can accelerate the computation of matrix-matrix, matrix-vector, and vector-vector operations.

In some aspects, the LSU 202 may be configured to provide a packet (e.g., including at least one of an opcode and a payload) that includes an SME request (e.g., instruction in the SME instruction set) for the hardware accelerator 208. For example, the CPU 200 may be configured to provide a first type of packet (e.g., referred to as SME datapath) for the matrix execution pipeline of the hardware accelerator 208 and a second type of packet (e.g., referred to as a SME Load/Store) for the LSU execution pipeline of the hardware accelerator 208.

It should be appreciated that the matrix execution pipeline of the hardware accelerator 208 and the LSU execution pipeline of the hardware accelerator 208 may be independent processing paths included in the architecture of the hardware accelerator 208. For example, the LSU execution pipeline may be configured for efficient memory access to ensure that data can be fetched from or written to memory with minimal latency and therefore may include hardware components (e.g., memory controller, address generation units, data buffers, etc.) to facilitate such efficient memory accesses with minimal latency. The matrix execution pipeline may be configured for performing arithmetic and logical operations on data and therefore may include hardware components configured to efficiently execute the arithmetic and logical operations associated with target applications (e.g., matrix operations, convolutions, etc.) of the hardware accelerator 208. By separating the load-store execution pipeline and the matrix execution pipeline, the hardware accelerator 208 may experience improved throughput and reduced latency associated with memory accesses.

It should be appreciated that an opcode that is included in a given SME request may be a numerical code that represents a specific instruction of the plurality of different SME instructions that can be included in the given SME request. It should also be appreciate that a payload may refer to the actual data that the hardware accelerator 208 may manipulate based on the opcode included in the given SME request.

In some aspects, the size of the packet may range from 1-word (e.g., 8 bits) to 5-words (e.g., 40 bits) depending on the packet type (that is, first type for the matrix execution pipeline or second type for the LSU execution pipeline). Furthermore, in some aspects, the format of the packet may vary based on the type of packet. For example, the second type of packet (e.g., SME Load/Store) may follow the following format: opcode (1-word); packet type; physical address; memory/ordering attribute; coherent/non-coherent memory; and region table pointer (4K memory region to which load is performed).

In some aspects, the RAQ 204 may be configured to track packets (e.g., including SME requests) for the hardware accelerator 208. The RAQ may also be further configured to track load/store requests for the CPU 200. In this manner, the RAQ 204 may be considered a shared structure. Furthermore, the RDB 206 may receive the packets (e.g., including an op-code and payload) from the LSU 202 that are intended for the hardware accelerator 208.

In some aspects, the RDB 206 may be configured to store packets (e.g., including SME requests) for the hardware accelerator 208. The LLC 210 may be configured to obtain a packet stored in the RDB 206 and, as soon as the LLC 210 obtains the packet, information associated with an SME request included in the packet may be removed (e.g., dequeued) from the RAQ 204. In this manner, by removing information stored in the RAQ 204 and associated with a given SME request as the LLC 210 obtains the given SME requests from the RDB 206, the RAQ 204 may provide an up-to-date (e.g., current) accounting of SME requests remaining for the hardware accelerator to execute.

It should be appreciated that, in some aspects, the LLC 210 may support a 32-byte interface that may be used to retrieve packets from the CPU 200, specifically the RDB 206 thereof, and provide the packets to the hardware accelerator 208. In other aspects, the LLC 210 may support an even larger interface. For example, in some aspects, the LLC 210 may support a 64-byte interface.

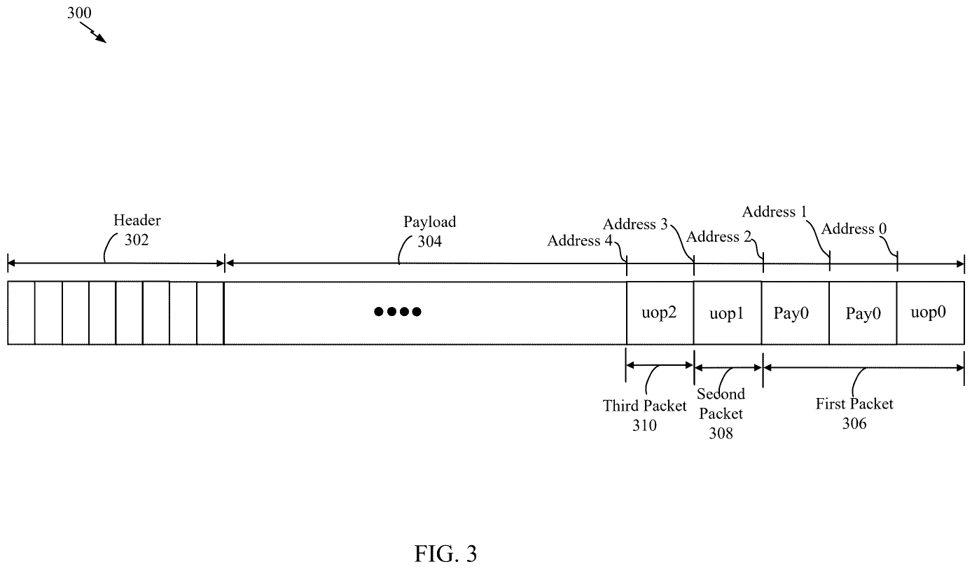

The CPU 200 may support a throughput of two instructions (e.g., SME requests) per clock cycle from the LSU 202 to the RAQ 204 and RDB 206. In some aspects, the CPU 200 may support a higher throughput, such as 4 instructions per clock cycle from the LSU 202 to the RAQ 204 and RDB 206. With existing approaches though, the instructions are enqueued in the RAQ 204 and the RDB 206 without any merging. And, without merging the instructions, the CPU 200 can only sustain a throughput of less than 1 instruction per clock cycle to the hardware accelerator 208. This sub-optimal throughput of instructions (e.g., SME requests) from the LSU 202 of the CPU 200 to the hardware accelerator 208 may result in waste, such as increased idle time of the hardware accelerator 208 given the instruction throughput (e.g., 2 instructions per clock cycle) of the hardware accelerator 208 is higher than the instruction throughput (e.g., less than 1 instruction per clock cycle) of the CPU 200. As will now be discussed with reference to FIG. 3, techniques disclosed herein involve merging multiple instructions (e.g., SME requests) stored in the RDB 206 to improve the instruction throughput from the CPU 200 to the hardware accelerator 208 to eliminate (or at least reduce) waste (e.g., increased idle time) that occurs when the instruction throughput of the CPU 200 is less than the instruction throughput of the hardware accelerator 208.

### Example Request Data Packet Generated at Request Data Buffer and Including Multiple Instructions

FIG. 3 depicts a request packet 300 for a hardware accelerator according to some aspects of the present disclosure.

The request packet 300 may include a header 302 and a payload 304. In some aspects, the header 302 of the request packet 300 may be of a first size (e.g., 8 bytes or 2 words), whereas the payload 304 of the request packet 300 may be of a second size (e.g., 56 bytes or 14 words) that is different (e.g, larger) than the first size.

As illustrated, the request packet 300 may include three different SME requests merged in the payload 304 thereof. For instance, multiple (e.g., 3) packets for a hardware accelerator (e.g., the hardware accelerator 208 of FIG. 2) may be merged at the request data buffer and stored in the payload 304 of the request packet 300 as illustrated. For example, the payload 304 of the request packet 300 may include a first packet 306 (e.g., ending at address 2 of the payload 304) for the hardware accelerator 208, a second packet 308 (e.g., ending at address 3 of the payload 304) for the hardware accelerator 208, and a third packet 310 (e.g., ending at address 4 of the payload 304) for the hardware accelerator 208.

As illustrated, a first address (e.g., labeled Address 0) of the payload 304 of the request packet 300 may include an opcode (e.g., labeled uop0) associated with the first packet 306. A second address (e.g., labeled Address 1) of the payload 304 and a third address (e.g., labeled Address 2) of the payload 304 may each include payload data (e.g., Pay0) associated with the first packet 306. It should be appreciated that the payload data may include the addresses (e.g., of memory) that the hardware accelerator operates on when executing the opcode (e.g., uop0). As further illustrated, a fourth address (e.g., labeled Address 3) of the payload 304 may include an opcode (e.g., labeled uop1) associated with the second packet 308 and a fifth address (e.g., labeled Address 4) of the payload 304 may include an opcode (e.g., labeled uop2) associated with the third packet 310.

In some aspects, the first packet 306 may include a first type of SME request (e.g., SME Load/Store instructions for the load-store execution pipeline of the hardware accelerator), whereas the second packet 308 and the third packet 310 may each include a second type of SME request (e.g., matrix instructions for the matrix execution pipeline of the hardware accelerator). Furthermore, since the first packet 306 is of a different type than each of the second packet 308 and the third packet 310, a size (e.g., number of words) of the first packet 306 may be different (e.g., larger) than a size of each of the second packet 308 and the third packet 310. For example, the first packet 306 may be 3 words long (e.g., due to the first packet 306 including an opcode and payload data, whereas the second packet 308 and the third packet 310 may each be 1 word long (e.g., due to the second packet 308 and the third packet 310 each including a single opcode).

In some aspects, the header 302 of the request packet 300 may store metadata associated with each of the packets (e.g., first packet 306, second packet 308, third packet 310) merged in the payload 304 of the request packet 300. For example, in some aspects, the metadata may include an end-pointer for each of the packets. More specifically, the end-pointer of the first packet 306 may correspond to a second address (e.g., labeled Address 2) of the payload 304. Additionally, the end-point of the second packet 308 may correspond to a third address (e.g., labeled Address 3) of the payload 304, and the end point of the third packet 310 may correspond to a fourth address (e.g., labeled Address 4) of the payload 304.

The metadata included in the header 302 of the request packet 300 may help the hardware accelerator 208 unpack (and issue) the multiple instructions (e.g., SME request included in the first packet 306, SME request included in second packet 308, and SME request included in third packet 310) for the hardware accelerator 208 that are stored in the payload 304 of the request packet 300. Furthermore, since each of the multiple packets included in the payload 304 of the request data packet represents a separate instruction (e.g., SME request) for the hardware accelerator 208, the disclosed techniques (that is, merging data packets at the RDB 206 to generate the request packet 300) may improve the throughput of instructions from the CPU to the hardware accelerator 208 per clock cycle such that the throughput of instructions matches (or, in the case of the request packet 300 of FIG. 3, exceeds) the instruction throughput of the hardware accelerator 208 and therefore eliminates (or at least reduces) waste in the form of increased idle times that the hardware accelerator 208 experiences when the throughput of instructions from the CPU to the hardware accelerator is less than the throughput of instructions that the hardware accelerator 208 is capable of handling per clock cycle.

In some aspects, the disclosed techniques may include determining whether a packet (e.g., including a SME request) that the RDB 206 receives from the LSU 202 can be merged with other packets received from the LSU 202 and stored in the RDB 206. For instance, in some aspects, a receive packet may include a particular SME request (e.g., a specific instruction in the SME instruction set) that cannot be merged with other instructions in the SME instruction set. For example, a load-store instruction included in the SME instruction set and for the hardware accelerator 208 to read/write a new physical address region cannot be merged with other instructions for the hardware accelerator 208. For instance, one or more features (e. g,. size of packet, format of packet) associated with the particular load-store instruction may impact the ability of the hardware accelerator 208 to accurately decode the particular load-store instruction from a packet (e. g, request packet) including the particular load-store instruction and one or more additional instructions. Thus, such instructions are sent to the hardware accelerator (e.g., via the LLC) without being merged with other instructions for the hardware accelerator that are stored in the RDB 206.

### Example Method for Communicating SME Requests to a Hardware Accelerator

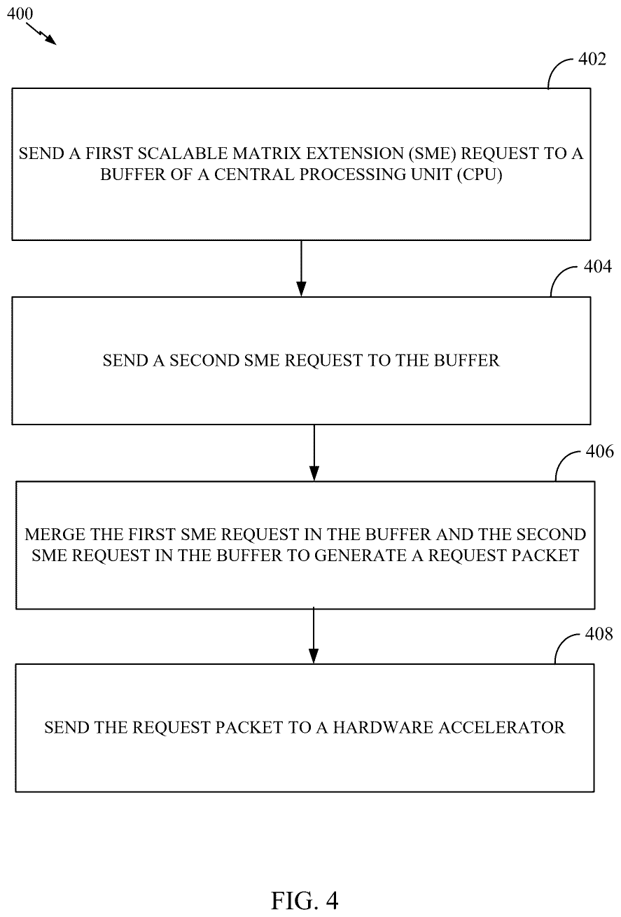

FIG. 4 depicts a method 400 for packing SME requests according to some aspects of the present disclosure. For example, the method 400 may be performed by the CPU 200 of FIG. 2. Furthermore, although FIG. 4 depicts steps performed in a particular order for purposes of illustration and discussion, the method 400 discussed herein is not intended to be limited to any particular order or arrangement. One skilled in the art, using the disclosure provided herein, will appreciate that various steps of the method 400 can be omitted, rearranged, combined and/or adapted in various ways without deviating from the scope of the present disclosure.

At 402, the method 400 includes sending a first SME request to a buffer of a CPU. For example, the CPU may enter a streaming mode (e.g., associated with SME) and a LSU of the CPU may send the first SME request to the buffer of the CPU.

At 404, the method 400 includes sending a second SME request to the buffer. For example, the LSU of the CPU may send the second SME request to the buffer of the CPU.

At 406, the method 400 includes merging the first SME request in the buffer and the second SME request in the buffer to generate a request packet. For example, in some aspects, the first SME request and the second SME request may be merged in a payload of the request packet. Furthermore, in some aspects, a header of the request packet may include metadata associated with each of the first SME request and the second SME request in the payload of the request packet. For instance, the metadata may indicate an end-pointer for the first SME request and an end-pointer for the second SME request. The first end-pointer and the second end-pointer may indicate an end address for the first SME request and the second SME request, respectively, in the payload of the request packet.

In some aspects, merging the first SME request in the buffer and the second SME request in the buffer may include determining whether the first SME request and the second SME request can be merged with one another to generate the request packet. For example, in some aspects, the method 400 may, at 406, include comparing one or more attributes (e.g., size, format, type of SME instruction, etc.) of the first SME request and one or more attributes of the second SME request. For example, the one or more attributes of the first SME request and the one or more attributes of the second SME request may be compared to attributes that are determined to be associated with SME requests that can be merged with other SME requests. For example, the size of the first SME request and the second SME request may be compared to a threshold size. If the size of the first SME request and the second SME request each satisfy (e.g., are less than) the threshold size, then the first SME request and the second SME request may be merged with one another to generate the request packet. Alternative, or additionally, a type of the SME instruction associated with the first SME request and a type of the SME instruction associated with the second SME request. For example, if one of the first SME request or the second SME request is associated with a SME instruction in the SME instruction set that is associated with a load-store operation to a new area of memory, then the two requests (that is, the first SME request and the second SME request cannot be merged with one another to generate the request packet.

At 408, the method 400 includes sending the request packet to a hardware accelerator. For example, in some aspects, sending the request packet to the hardware accelerator may include retrieving the request packet from the buffer of the CPU and temporarily storing the request packet in a last level cache of the CPU before providing the request packet to the hardware accelerator. In some aspects, the hardware accelerator may unpack the multiple SME requests included in the payload of the request packet based on the metadata that is included in the header of the request packet. Furthermore, the hardware accelerator may, upon unpacking the multiple SME requests included in the request pack, issue the multiple SME requests to respective pipelines (e.g., matrix execution pipeline and/or LSU execution pipeline) of the hardware accelerator.

### Example Processing System for Communicating SME Requests

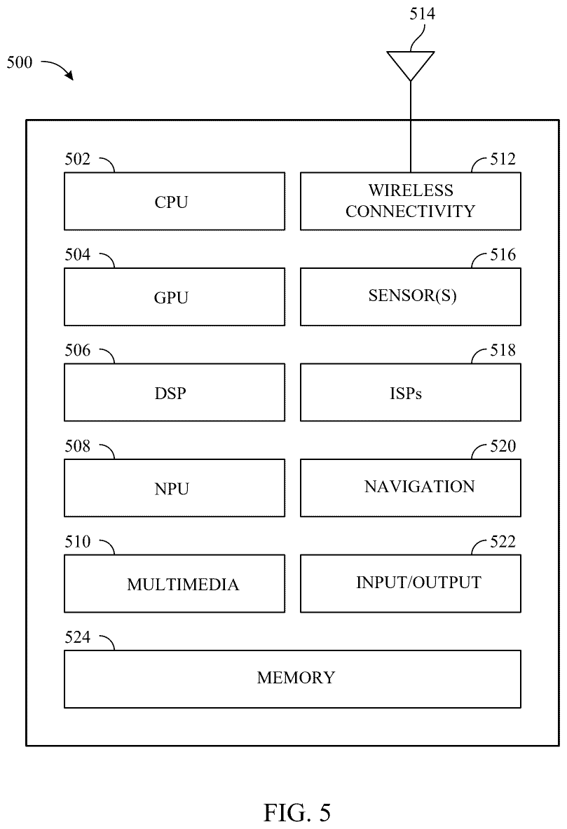

In some aspects, the techniques and methods described with reference to FIGS. 2-4 may be implemented on one or more devices or systems. FIG. 5 depicts an example processing system 500 configured to perform various aspects of the present disclosure, including, for example, the techniques and methods described with respect to FIGS. 2-4. In some aspects, the processing system 500 may include the CPU cluster 100 discussed above with reference to FIG. 1. Although depicted as a single system for conceptual clarity, in some aspects, as discussed above, the operations described below with respect to the processing system 500 may be distributed across any number of devices or systems.

The processing system 500 includes a central processing unit (CPU) 502 (e.g., corresponding to one of the CPUs 110 of FIG. 1). Instructions executed at the CPU 502 may be loaded, for example, from a cache memory associated with the CPU 502.

The processing system 500 also includes additional processing components tailored to specific functions, such as a graphics processing unit (GPU) 504, a digital signal processor (DSP) 506, a neural processing unit (NPU) 508, a multimedia component 510 (e.g., a multimedia processing unit), and a wireless connectivity component 512.

An NPU, such as NPU 508, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS), as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

Generally, the processing system 500 and/or components thereof may be configured to perform the methods described herein.

Notably, in other aspects, elements of the processing system 500 may be omitted, such as where the processing system 500 is a server computer or the like. For example, the multimedia component 510, the wireless connectivity component 512, the sensor processing units 516, the ISPs 518, and/or the navigation processor 520 may be omitted in other aspects. Further, aspects of the processing system 500 may be distributed between multiple devices.

### EXAMPLE CLAUSES

Implementation examples are described in the following numbered clauses:

### Aspect 1

A method for communicating scalable matrix extension (SME) requests to a hardware accelerator, the method comprising: sending a first SME request to a buffer of a central processing unit; sending a second SME request to the buffer; merging the first SME request in the buffer and second SME request in the buffer to generate a request packet; and sending the request packet to the hardware accelerator.

### Aspect 2

The method of Aspect 1, wherein the first SME request and the second SME request each include information comprising at least one of an opcode and a payload; and the request packet includes a payload comprising the information for the first SME request and the information for the second SME request.

### Aspect 3

The method of Aspect 2, wherein: the request packet includes a header comprising information indicating a location of the information for the first SME request in the payload and a location of the information for the second SME request in the payload.

### Aspect 4

The method of any of Aspects 1 to 3, wherein: the first SME request comprises a load-store operation; and the second SME request comprises a matrix operation.

### Aspect 5

The method of any of Aspects 1 to 4, wherein: determine the first SME request and the second SME request can be merged based on comparing one or more attributes of the first SME request and one or more attributes of the second SME request; and merging the first SME request and the second SME request to generate the request packet for the hardware accelerator based on determining the second SME request and the second SME request can be merged.

### Aspect 6

The method of any of Aspects 1 to 5, wherein sending comprises: determining the request packet includes a threshold number of SME requests; and sending the request packet to the hardware accelerator based on the determining the request packet includes the threshold number of SME requests.

### Aspect 7

The method of Aspect 6, wherein the threshold number of SME requests ranged from 7 SME request to 10 SME requests.

### Aspect 8

The method of any of Aspects 1 to 7, wherein the sending comprises: determining a payload of the request packet includes a threshold number of words; and sending the request packet to the hardware accelerator based on determining the payload includes the threshold number of words.

### Aspect 9

The method of Aspect 8, wherein the threshold number of words ranges from 10 words to 16 words.

### Aspect 10

The method of any of Aspects 1 to 9, wherein sending the request packet to the hardware accelerator comprises sending the request packet to a last level cache communicatively coupled to the central processing unit and the hardware accelerator.

### Aspect 11

A processing system comprising: a hardware accelerator; and a central processing unit (CPU) including a load-store unit (LSU), a buffer communicatively coupled to the LSU, and a last level cache communicatively coupled to the buffer and the hardware accelerator, the CPU configured to: send a first SME request from the LSU to the buffer; send a second SME request from the LSU to the buffer; merge the first SME request in the buffer and second SME request in the buffer to generate a request packet; and send the request packet to the hardware accelerator via the last level cache.

### Aspect 12

The processing system of Aspect 11, wherein: the first SME request and the second SME request each include information comprising at least one of an opcode and a payload; and the request packet includes a payload comprising the information for the first SME request and the information for the second SME request.

### Aspect 13

The processing system of Aspect 12, wherein: the request packet includes a header comprising information indicating a location of the information for the first SME request in the payload and a location of the information for the second SME request in the payload.

### Aspect 14

The processing system of any of Aspects 11 to 13, wherein: the first SME request comprises a load-store operation; and the second SME request comprises a matrix operation.

### Aspect 15

The processing system of any of Aspects 11 to 14, wherein to merge the first SME request and the second SME request, the CPU is configured to: determine the first SME request and the second SME request can be merged based on one or more attributes of the first SME request and one or more attributes of the second SME request; and merge the first SME request and the second SME request to generate the request packet for the hardware accelerator.

### Aspect 16

The processing system of any of Aspects 11 to 15, wherein to send the request packet, the CPU is configured to: determine the request packet includes a threshold number of SME requests; and send the request packet to the hardware accelerator based on determining the request packet includes the threshold number of SME requests.

### Aspect 17

The processing system of any of Aspects 11 to 17, wherein to send the request packet, the CPU is configured to: determine a payload of the request packet includes a threshold number of words; and send the request packet to the hardware accelerator based on determining the payload includes the threshold number of words.

### Aspect 18

The processing system of any of Aspects 11 to 17, wherein: the CPU further comprises an address queue configured to queue a first address associated with the first SME request and a second address associated with the second SME request; and the CPU is further configured to dequeue the first address from the address queue and the second address from the address queue based on sending the request packet.

### Aspect 19

The processing system of any of Aspects 11 to 18, wherein the hardware accelerator includes a matrix execution pipeline and a load-store execution pipeline.

### Aspect 20

An apparatus comprising: means for sending a first SME request to a buffer of a central processing unit; means for sending a second SME request to the buffer; means for merging the first SME request in the buffer and second SME request in the buffer to generate a request packet; and means for sending the request packet to a hardware accelerator.

### Aspect 21

The apparatus of Aspect 20, further comprising means for performing the method according to any of Aspects 2 to 10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

For example, means for sending a first SME request to a buffer of a central processing unit (e.g., LSU 202 in FIG. 2) and means for sending a second SME request to the buffer (e.g., also LSU 202 in FIG. 2). Means for merging the first SME request in the buffer and second SME request in the buffer to generate a request packet (e.g., CPU 200 in FIG. 2). Means for sending the request packet to a hardware accelerator (e.g., LLC 210 in FIG. 2).

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for communicating instructions to a hardware accelerator, comprising:
sending a first instruction the hardware accelerator to a buffer;
sending a second instruction for the hardware accelerator to the buffer;
merging the first instruction in the buffer and second instruction in the buffer to generate an instruction packet; and
sending the instruction packet to the hardware accelerator.

2. The method of claim 1, wherein:
the first instruction and the second instruction each include information comprising at least one of an opcode and a payload; and
the instruction packet includes a payload comprising the information for the first instruction and the information for the second instruction.

3. The method of claim 2, wherein:
the instruction packet includes a header comprising information indicating a location of the information for the first instruction in the payload and a location of the information for the second instruction in the payload.

4. The method of claim 1, wherein:
the first instruction comprises a load-store operation; and
the second instruction comprises a matrix operation.

5. The method of claim 1, wherein merging the first instruction and the second instruction comprises:
determining whether the first instruction and the second instruction can be merged based on comparing one or more attributes of the first instruction and one or more attributes of the second instruction; and
merging the first instruction and the second instruction to generate the instruction packet based on determining the first instruction and the second instruction can be merged.

6. The method of claim 2, wherein sending comprises:
determining the payload of the instruction packet includes a threshold number of instructions; and
sending the instruction packet to the hardware accelerator based on determining the instruction packet includes the threshold number of instructions.

7. The method of claim 6, wherein the threshold number of instructions ranges from 7 requests to 10 requests.

8. The method of claim 1, wherein the sending comprises:
determining a payload of the instruction packet includes a threshold number of words; and
sending the instruction packet to the hardware accelerator based on determining the payload includes the threshold number of words.

9. The method of claim 8, wherein the threshold number of words ranges from 10 words to 16 words.

10. The method of claim 1, wherein sending the instruction packet to the hardware accelerator comprising sending the instruction packet to the hardware accelerator via a memory that is communicatively coupled to the hardware accelerator.

11. A processing system comprising:
a hardware accelerator;
a memory communicatively coupled to the hardware accelerator; and
a central processing unit (CPU) communicatively coupled to the memory, the CPU configured to:
send a first instruction from a load-store unit (LSU) to a buffer;
send a second instruction from the LSU to the buffer, the second instruction being different from the first instruction;
merge the first instruction in the buffer and the second instruction in the buffer to generate an instruction packet; and
send the instruction packet to the hardware accelerator via the memory.

12. The processing system of claim 11, wherein:
the first instruction and the second instruction each include information comprising at least one of an opcode and a payload; and
the instruction packet includes a payload comprising the information for the first instruction and the information for the second instruction.

13. The processing system of claim 12, wherein:
the instruction packet includes a header comprising information indicating a location of the information for the first instruction in the payload and a location of the information for the second instruction in the payload.

14. The processing system of claim 11, wherein:
the first instruction comprises a load-store operation; and
the second instruction comprises a matrix operation.

15. The processing system of claim 11, wherein to merge the first instruction and the second instruction, the CPU is configured to:
determine the first instruction and the second instruction can be merged based on one or more attributes of the first instruction and one or more attributes of the second instruction; and
in response to determining the first instruction and the second instruction can be merged, merge the first instruction and the second instruction to generate the instruction packet for the hardware accelerator.

16. The processing system of claim 11, wherein to send the instruction packet, the CPU is configured to:
determine the instruction packet includes a threshold number of instructions; and
send the instruction packet to the hardware accelerator based on determining the instruction packet includes the threshold number of instructions.

17. The processing system of claim 12, wherein to send the instruction packet, the CPU is configured to:
determine the payload of the instruction packet includes a threshold number of words; and
send the instruction packet to the hardware accelerator based on determining the payload includes the threshold number of words.

18. The processing system of claim 11, wherein:
the CPU further comprises an address queue configured to queue a first address associated with the first instruction and a second address associated with the second instruction; and
the CPU is further configured to dequeue the first address from the address queue and the second address from the address queue based on sending the instruction packet.

19. The processing system of claim 11, wherein the hardware accelerator includes a matrix execution pipeline and a load-store execution pipeline.

20. A processing system comprising:
a hardware accelerator;
a cache communicatively coupled to the hardware accelerator; and
a central processing unit (CPU) communicatively coupled to the cache, the CPU configured to:
send a first hardware extension instruction from a load-store unit (LSU) to a buffer;
send a second hardware extension instruction from the LSU to the buffer, the second hardware extension instruction being different from the first hardware extension instruction;
determine the first hardware extension instruction and the second hardware extension instruction can be merged based on one or more attributes of the first hardware extension instruction and one or more attributes of the second hardware extension instruction;
merge the first hardware extension instruction and the second hardware extension instruction to generate an instruction packet for the hardware accelerator;
determine the instruction packet is ready to send to the hardware accelerator based, at least in part, on one or more attributes of a payload of the instruction packet; and
send the instruction packet to the hardware accelerator via the cache.
